(19) United States
(12) Patent Application Publication
(10) Pub. No.: US 2012/0247025 A1
(43) Pub. Date: Oct. 4, 2012

(54) FINE PERFORATED SHIELD FOR AUTOMOBILES

(76) Inventor: Azza Abd El-Moneim El-Segal, Gharbiya (EG)

(21) Appl. No.: 13/499,982

(22) PCT Filed: Sep. 29, 2010
(86) PCT No.: PCT/EG10/00038

§ 371 Date: Apr. 3, 2012

(30) Foreign Application Priority Data
Oct. 4, 2009 (EG) 2009101466

(51) Int. Cl. B60J 3/00; B60R 11/00; B60J 10/04

(52) U.S. Cl. 49/489.1; 160/370.21; 224/482

(57) ABSTRACT

Fine perforated shield (1) for automobiles having the same dimension as the window and being supported by a reinforcing frame (2). This shield should provide aeration to the automobiles to prevent suffocation, asphyxia or even death of the remaining passengers when the driver is forced to stop the motor for taking a break or sleeping for refreshment during long travels. It also should protect against mosquitos, reptiles, snakes etc. and especially against robbers and thieves. The arrangement is placed to the inside position of the glass window and includes additional nm channels and seals. It is resistant to cutting, scratching and burning and can be controlled manually or electrically with a window regulator having a locking button.

### (1) TECHNICAL FIELD

The present invention is related to automobile Industry. Installing a layer of fine perforated shield, to supply fresh renewable aeration to the automobiles, to prevent suffocation, asphyxia or even death of the driver and the remaining passengers, as on closing the windows there would be a non renewable limited aeration especially when the driver is to be forced to take breaks or sleep for refreshment during the long travels. Also to protect (act as a filter) guard against mosquito bites or inset stings with their infectious diseases. Moreover avoid entrance of the reptiles, the snakes and scorpions especially in the desert and mountain areas. Furthermore protect the automobiles and the passengers from being attacked by robbers and thieves (would not being stolen).

### (2) BACKGROUND ART

One of the main drawbacks of the current ventilation system in all cars windows is the presence of glass windows that can be opened and closed either manually or electrically. On closing such a windows ventilation enjoy fresh air inside the car would be limited and non-renewable that would cause either suffocation or asphyxia or even death of the driver and the remaining passengers, especially when the driver is to be forced to take breaks or sleep to renew his leadership once again, especially during the long travels by road.

If the driver would leave the car windows opened for aeration he and the passengers would be subjected to either

1. Mosquito bites or (flying and crawls) insects stings. This would increase their vulnerability to infectious diseases.

2. The entry of the reptiles or aircraft into the car and exposure to infection with its attendant damage.

3. The snakes or scorpions would also enter the cars especially in the desert and mountain areas with exposure to accompanying poisons.

4. Furthermore the cars or some contents and the passengers would be attacked by robbers and thieves (would be stolen).

5. Also, they would be subjected to wild animals (predators) attack especially in mountainous regions.

### (3) DISCLOSURE OF INTERVENTION

Add or installing a layer of fine perforated shield supported with a reinforcing frame having the same original car windows dimensions and attached to a revision in the rubber gasket (glass urethane) related to the car window (window run channel seals) with an additional groove (additional run channel) to ensure easy and safety slipping up and down movement of the shield without any harm or damage.

Properties of such shield should be:
1. Easy to manufacture, installation and use without damage or harm its users.
2. After installation in the window of the car to be resistant to cutting, scratching, or burning.
3. Maintains its dimensions and relatively not much affected by heat of the sun and the cold weather.
4. Resist corrosion and rusting.
5. Poor conductors to temperature and electricity.
6. Easy to open and close either manually, mechanically, or electrically by window regulator machine.
7. Ease of processing having different sizes and forms that fit and suits various cars windows and mini-buses and buses, as well as transport vehicles and trucks (buses).

### (4) BRIEF DESCRIPTION OF DRAWINGS

1. Fine perforated shield with reinforcing frame.

2. Urethane (rubber gasket) with two running channels for both the glass window and the fine perforated shield.

3. Anterior and posterior Hail with two incorporated running channels in case of the vertically divided windows.

4. Urethane (rubber gasket) with anterior and posterior Hail incorporating two running channels for both the glass window and the line perforated shield.

5. Holders or carriers one for glass window and another for the line perforated shield

6. Box of grouped horizontally arranged buttons for both/either the glass window and/or the fine perforated shield.

7. Box of grouped vertically arranged buttons for both/either the glass window and/or the fine perforated shield.

### (5) DETAIL DESCRIPTION OF DRAWINGS

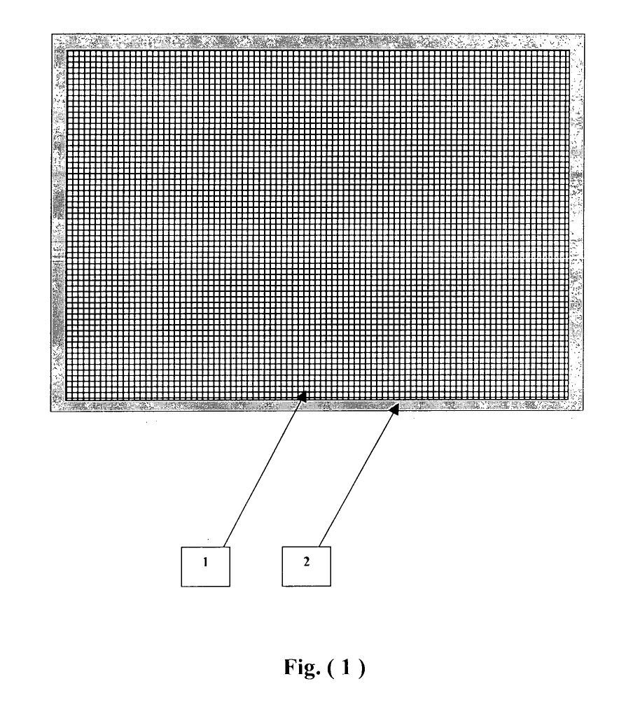

### (FIG. 1)

8. Fine perforated shield.

9. A frame within the vicinity of the shield.

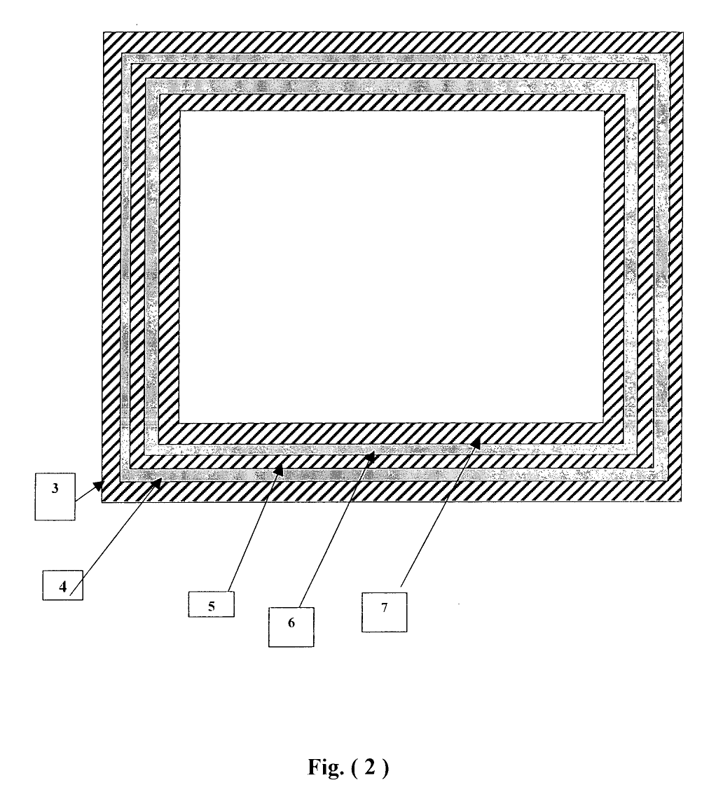

### (FIG. 2)

10. Elevation on external rubber gasket is Albrooaz the outer reaches of the groove, in which glass window is moving.

11. Run channel in the course of a rubber gasket, in which glass window is moving.

12. The elevation in the rubber gasket in-between the run channel of glass window and the run channel of the shield.

13. Run channel where the shield moves.

14. The emergence of an internal rubber gasket is Albrooaz inner reaches of the groove, in which the shield is moving.

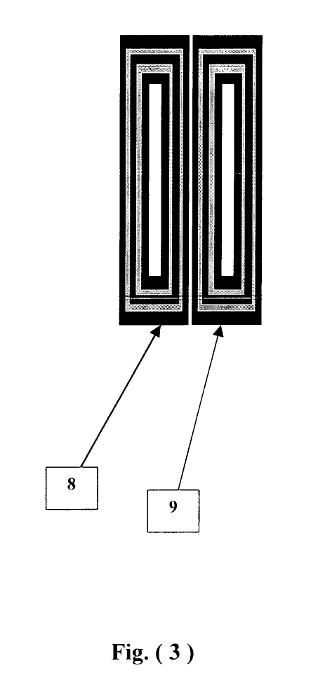

### (FIG. 3)

15. Anterior Hail at the middle represents the rubber around the window glass and the fine perforated shield in the case of the two parts divided window.

16. Posterior Hail at the middle represents the rubber around the window glass and the fine perforated shield in the case of the two parts divided window.

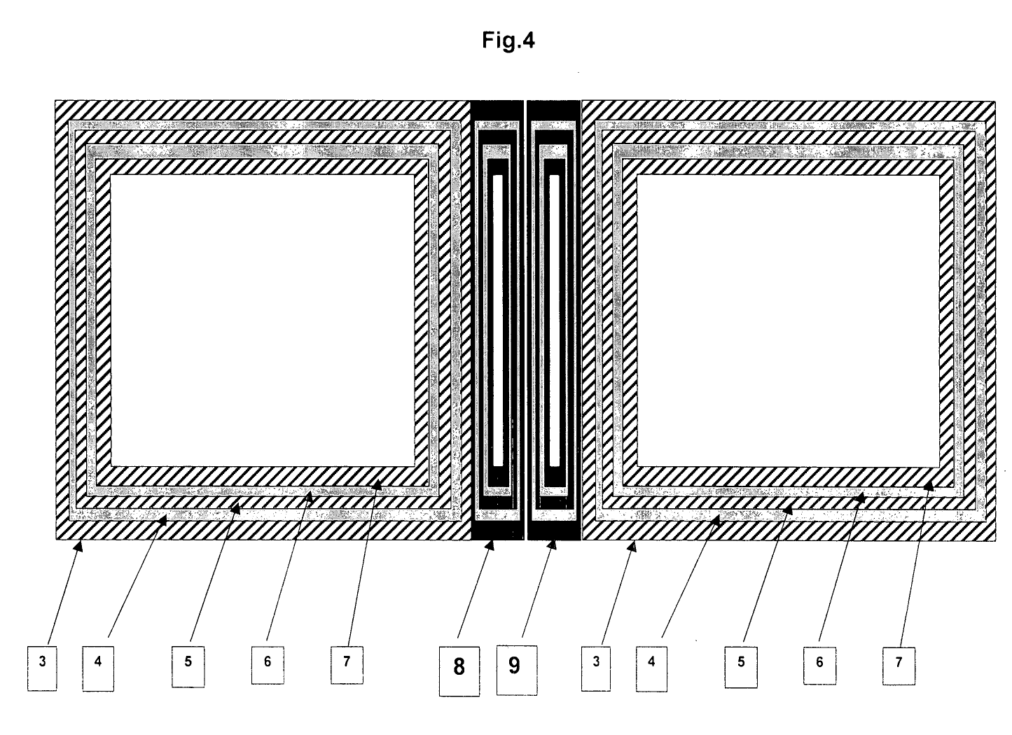

### (FIG. 4)

3. Elevation on external rubber gasket is Albrooaz the outer reaches of the groove, in which glass window is moving.

4. Run channel in the course of a rubber gasket, in which glass window is moving.

5. The elevation in the rubber gasket in-between the run channel of glass window and the run channel of the shield.

6. Run channel where the shield moves.

7. The emergence of an internal rubber gasket is Albrooaz inner reaches of the groove, in which the shield is moving.

8. Anterior Hail at the middle represents the rubber around the window glass and the fine perforated shield in the case of the two parts divided window.

9. Posterior Hail at the middle represents the rubber around the window glass and the fine perforated shield in the case of the two parts divided window.

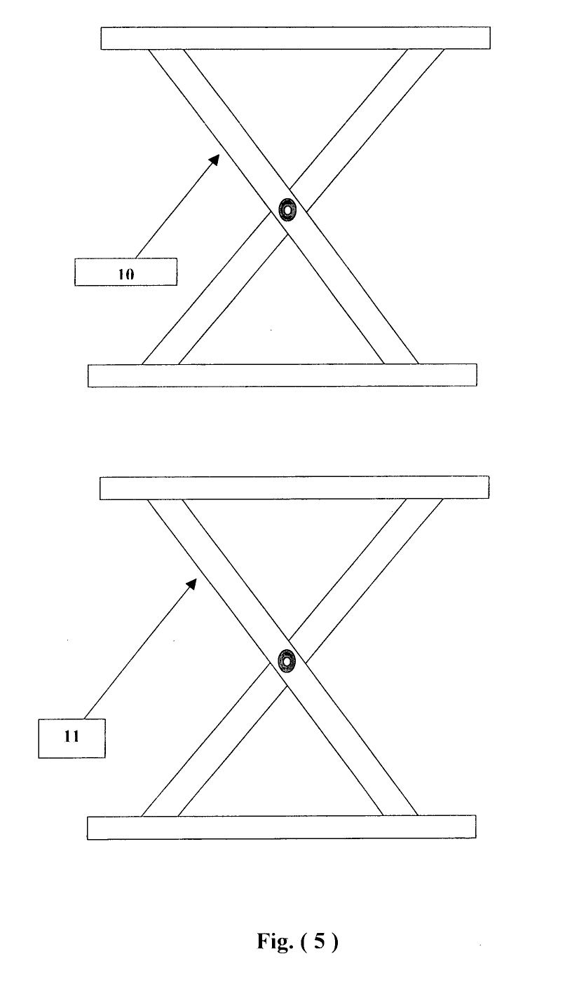

### (FIG. 5)

17. I-folder for a glass of the window and the focus (fulcrum) of the up and down movement.

18. Holder of the fine perforated shield and the focus (fulcrum) of the movement of opening up and down.

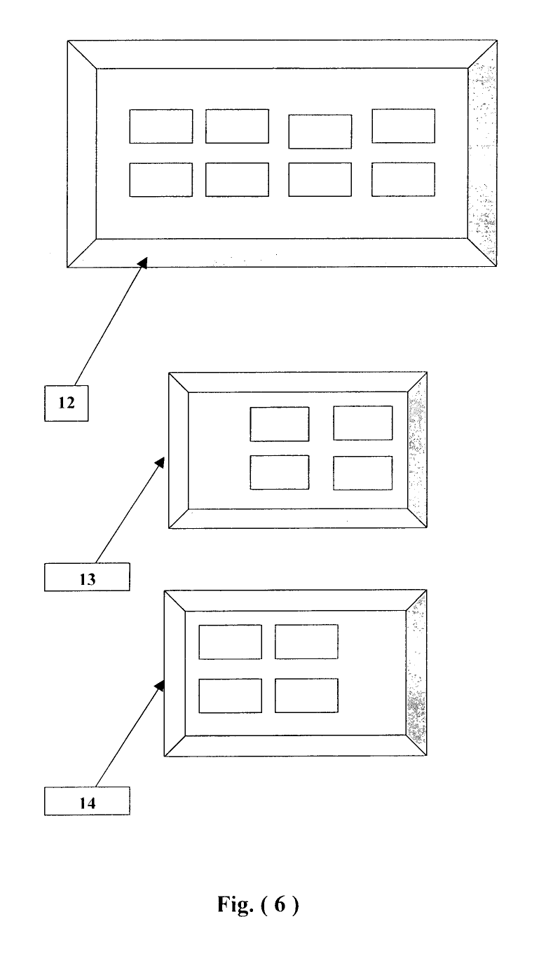

### (FIG. 6)

19. Box of grouped buttons to open and close both the glass window and the shield.

20. Box of grouped buttons to open and close the glass windows of the four separate buttons to open and close the fine perforated shield arranged horizontally.

21. Box of grouped open and close buttons of the shield separate from the buttons to open and close the window arranged horizontally

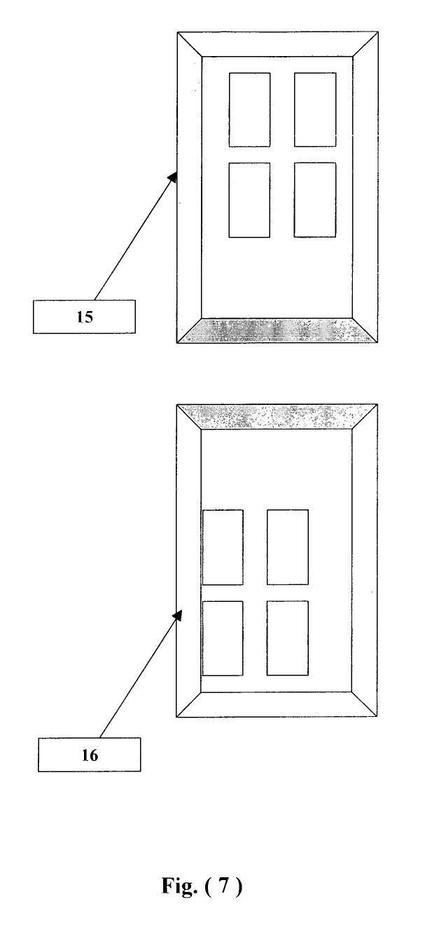

### (FIG. 7)

22. Box of grouped open and close buttons of the glass windows of the four separate open and close buttons for the fine perforated shield arranged vertically.

23. Box of grouped open and close buttons of the fine perforated shield separate from the open and close buttons for the window glass in upright position.

1- Fine perforated shield having the same dimensions of the window can be made of material that has a high durability and high-quality and supported by an external frame.

2- Window run channel seals or glass urethane related car door add an additional run channel in which to ensure ease up and down sliding movement of the shield placed to the inside position of the glass window.

3- Materials of the shield of the article have the following characteristics:
1. Ease of manufacture, installation and use without damage or harm its users.
2. After installation in the window of the car to be resistant to cutting, scratching, or burning.
3. Maintains relatively steady dimensions not much affected by natural phenomena such as heat of the sun, humidity and the cold weather.
4. Easy to open and close either manually, mechanically or electrically (window regulator such as that used to open and close the car windows).
5. Ease of manufacture and having different shapes, and sizes that Fit and suits various windows of all cars and mini-buses and buses, as well as transport vehicles and trucks.
6. This shield can be controlled by:
1. Manual (window regulator).
2. Electrically (window regulator) by clicking on up and down buttons.
3. Locking and Steadfastness button.

4- Special holder or carrier is designed to carry the shield can be mounted on the car and attached to the modified main window regulator, or to another specially mounted.

5- Device and the way in which the shield moves easily in run channel in a specially made of rubber gasket (glass urethane) related to car window either:
1. Manual window regulator to open and close the fine perforated shield.
2. Electrically regulator machine to open and close the fine perforated shield.
3. Button for locking and steadfastness.

6- Either modifying the window regulator machine to control the holder and fulcrum of both the glass window and the fine perforated shield, or mounting another special window regulator to control the shield.
